(19) United States
(12) Patent Application Publication
(10) Pub. No.: US 2026/0279685 A1
(43) Pub. Date: Sep. 17, 2026

(54) MULTILAYER CERAMIC CAPACITOR AND MOUNTING STRUCTURE OF MULTILAYER CERAMIC CAPACITOR

(71) Applicant: Murata Manufacturing Co., Ltd., Nagaokakyo-shi (JP)

(72) Inventors: Kazuhiro NISHIBAYASHI, Nagaokakyo-shi (JP); Kiyomi SAWAZAKI, Nagaokakyo-shi (JP)

(21) Appl. No.: 19/667,814

(22) Filed: May 5, 2026

Related U.S. Application Data
(63) Continuation of application No. PCT/JP2024/041069, filed on Nov. 20, 2024.

(30) Foreign Application Priority Data
Mar. 27, 2024 (JP) 2024-051911

(51) Int. Cl. H01G 4/30; H01G 4/224; H01G 4/232

(52) U.S. Cl. CPC H01G 4/30; H01G 4/224; H01G 4/232

(57) ABSTRACT

A multilayer ceramic capacitor includes a multilayer body including first and second main surfaces facing each other in a lamination direction, first and second side surfaces facing each other in a width direction orthogonal to the lamination direction, and first and second end surfaces facing each other in a length direction orthogonal to the lamination direction and the width direction. The multilayer ceramic capacitor also includes end surface outer electrodes provided as a pair on the respective end surfaces and side surface outer electrodes provided as a pair on the respective side surfaces. A surface roughness of the second main surface is higher than a surface roughness of the first main surface.

### CROSS REFERENCE TO RELATED APPLICATIONS

This application claims the benefit of priority to Japanese Patent Application No. 2024-051911 filed on Mar. 27, 2024 and is a Continuation Application of PCT Application No. PCT/JP2024/041069 filed on Nov. 20, 2024. The entire contents of each application are hereby incorporated herein by reference.

### BACKGROUND OF THE INVENTION

### 1. Field of the Invention

The present invention relates to multilayer ceramic capacitors and mounting structures of multilayer ceramic capacitors.

### 2. Description of the Related Art

Conventionally, there has been known a mounting structure of a multilayer ceramic capacitor including a mounting substrate, the multilayer ceramic capacitor, and a resin layer that covers a surface of the mounting substrate on which the multilayer ceramic capacitor is mounted (for example, Japanese Unexamined Patent Application Publication No. 2016-92289).

### SUMMARY OF THE INVENTION

When stress due to bending or the like is applied to the mounting substrate in a state in which the multilayer ceramic capacitor is mounted on the mounting substrate, there is a possibility that the stress is transmitted from the mounting substrate to the multilayer ceramic capacitor and cracks occur in a multilayer body. Such a problem is also a concern in the mounting structure including the resin layer.

Example embodiments of the present invention provide multilayer ceramic capacitors and mounting structures of multilayer ceramic capacitors that reduce or prevent damage to the multilayer ceramic capacitors.

A multilayer ceramic capacitor according to an example embodiment of the present invention includes a multilayer body including an inner layer portion including a plurality of dielectric layers and a plurality of inner electrodes, a first main surface and a second main surface facing each other in a lamination direction, a first side surface and a second side surface facing each other in a width direction orthogonal to the lamination direction, and a first end surface and a second end surface facing each other in a length direction orthogonal to the lamination direction and the width direction. The multilayer ceramic capacitor also includes outer electrodes provided as a pair on at least one of the pair of side surfaces or the pair of end surfaces. A surface roughness of the second main surface is higher than a surface roughness of the first main surface.

A mounting structure of a multilayer ceramic capacitor according to an example embodiment of the present invention includes a multilayer ceramic capacitor according to an example embodiment of the present invention, a mounting substrate including a mounting surface on which the multilayer ceramic capacitor is mounted, and a cover located on the mounting surface to cover the multilayer ceramic capacitor. The multilayer ceramic capacitor is mounted on the mounting substrate such that the first main surface faces the mounting surface side. The cover abuts against the second main surface.

According to example embodiments of the present invention, it is possible to provide multilayer ceramic capacitors and mounting structures of multilayer ceramic capacitors that reduce or prevent damage to the multilayer ceramic capacitor.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor and a mounting structure according to an example embodiment of the present invention.

FIG. 2 is a cross-sectional view taken along line II-II of FIG. 1.

FIG. 3 is a cross-sectional view taken along line III-III of FIG. 1.

FIG. 4 is a schematic diagram of the mounting structure according to a modification of an example embodiment of the present invention as viewed from a second side surface side of a multilayer body.

### DETAILED DESCRIPTION OF THE EXAMPLE EMBODIMENTS

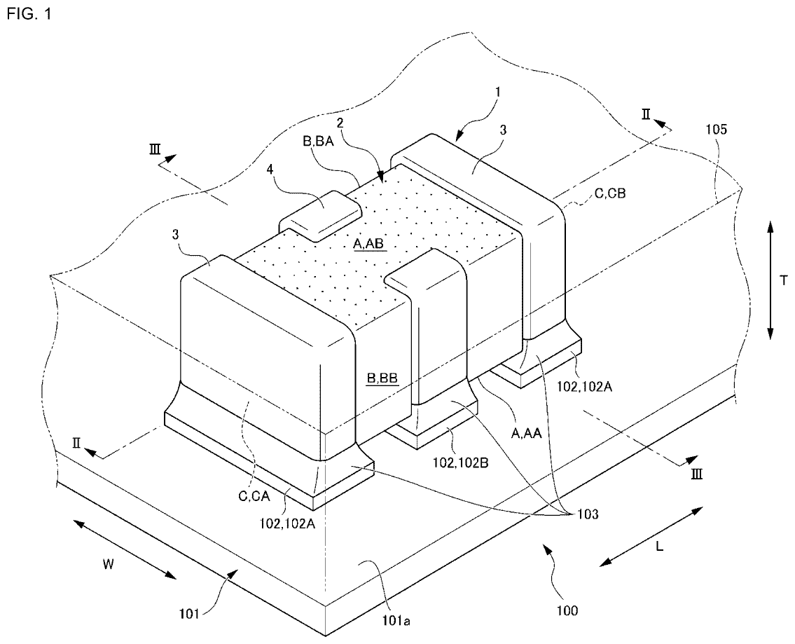

A mounting structure 100 of a multilayer ceramic capacitor according to an example embodiment of the present invention (sometimes referred to simply as “mounting structure 100”) is described below with reference to FIGS. 1 to 3. The mounting structure 100 includes a multilayer ceramic capacitor 1, a mounting substrate 101, and a cover 105. In FIG. 1, the cover 105 is depicted by imaginary lines.

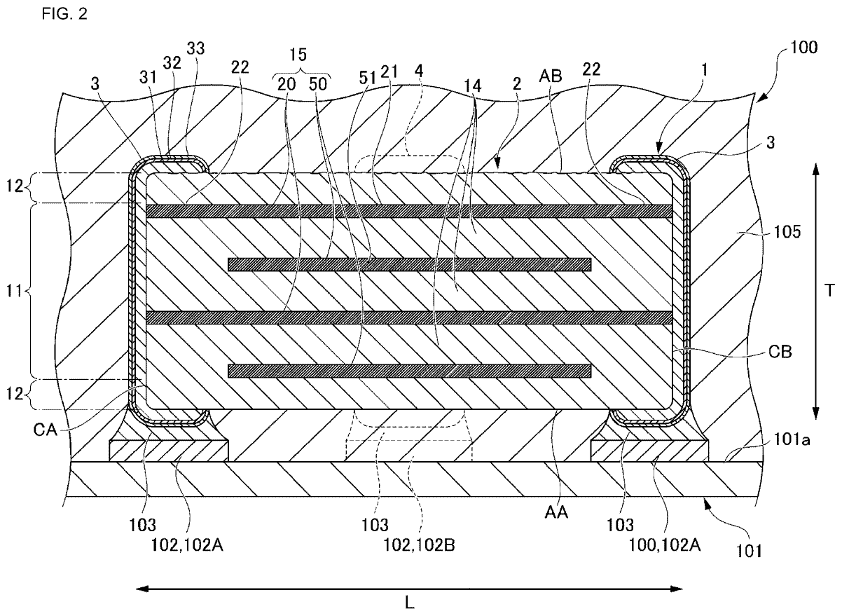

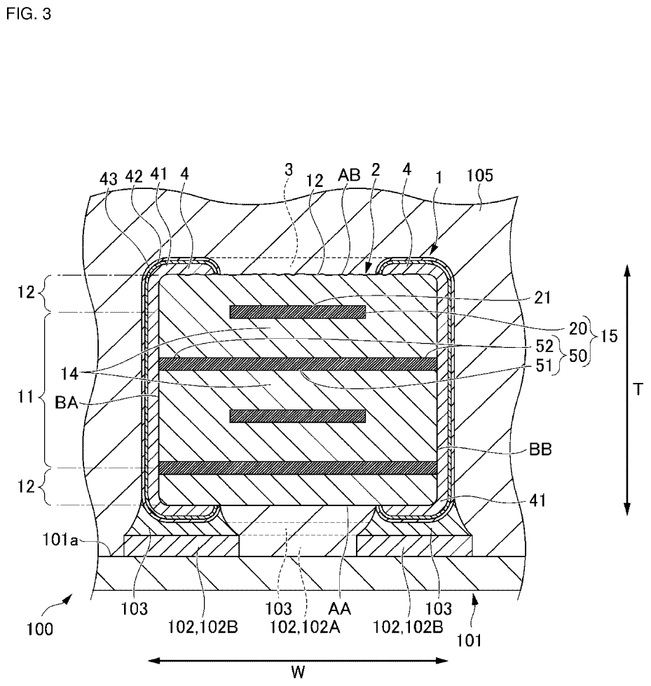

As depicted in FIG. 1, the multilayer ceramic capacitor 1 is a so-called three-terminal multilayer ceramic capacitor. The multilayer ceramic capacitor 1 includes a multilayer body 2, a pair of end surface outer electrodes 3, and a pair of side surface outer electrodes 4. The multilayer body 2 has a substantially rectangular parallelepiped shape, and has six outer surfaces. As depicted in FIGS. 2 and 3, the multilayer body 2 includes an inner layer portion 11 in which dielectric layers 14 and inner electrodes 15 are laminated. The end surface outer electrodes 3 and the side surface outer electrodes 4 are sometimes collectively referred to as the “outer electrodes 3 and 4.”

In the present specification, in the multilayer ceramic capacitor 1, a direction in which the dielectric layers 14 and the inner electrodes 15 are laminated is defined as a lamination direction T. One direction among directions orthogonal to the lamination direction T is defined as a length direction L. A direction orthogonal to each of the length direction L and the lamination direction T is defined as a width direction W.

Among the six outer surfaces of the multilayer body 2, a pair of outer surfaces disposed on both sides in the lamination direction T are defined as a first main surface AA and a second main surface AB. Further, a pair of outer surfaces that extend in the lamination direction T and are disposed on both sides in the width direction W are defined as a first side surface BA and a second side surface BB. In addition, a pair of outer surfaces that extend in the lamination direction T and are disposed on both sides in the length direction L are defined as a first end surface CA and a second end surface CB. The first main surface AA and the second main surface AB are sometimes collectively referred to as the “respective main surfaces A.” The first side surface BA and the second side surface BB are sometimes collectively referred to as the “respective side surfaces B.” The first end surface CA and the second end surface CB are sometimes collectively referred to as the “respective end surfaces C.”

A cross section parallel to the length direction L and the lamination direction T is referred to as an “LT cross section.” A cross section parallel to the width direction W and the lamination direction T is referred to as a “WT cross section.” A cross section parallel to the length direction L and the width direction W is referred to as an “LW cross section.” The cross section depicted in FIG. 2 is an LT cross section passing through a central portion of the multilayer body 2 in the width direction W. The cross section depicted in FIG. 3 is a WT cross section passing through a central portion of the multilayer body 2 in the length direction L.

In the multilayer ceramic capacitor 1, for example, a dimension in the length direction L is set to about 1100 μm or more and about 1300 μm or less, for example, within manufacturing and measurement tolerances. Further, a dimension in the width direction W is set to about 800 μm or more and about 1000 μm or less, and a dimension in the lamination direction T is set to about 600 μm or more and about 800 μm or less, for example, within manufacturing and measurement tolerances.

The multilayer body 2 has the inner layer portion 11 and a pair of outer layer portions 12 disposed on both sides of the inner layer portion 11 in the lamination direction T. It is preferable that corner portions and ridge portions be rounded in the multilayer body 2. The corner portions are portions at which three surfaces of the multilayer body intersect. The ridge portions are portions at which two surfaces of the multilayer body intersect. As dimensions of the multilayer body 2, for example, a dimension in the length direction L is set to about 0.9 mm or more and about 1.2 mm or less, for example, within manufacturing and measurement tolerances. Further, a dimension in the width direction W is set to about 0.7 mm or more and about 0.9 mm or less, and a dimension in the lamination direction T is set to about 0.5 mm or more and about 0.7 mm or less, for example, within manufacturing and measurement tolerances.

The inner layer portion 11 has a plurality of dielectric layers 14 and a plurality of inner electrodes 15. The dielectric layers 14 and the inner electrodes 15 are alternately laminated.

The dielectric layers 14 are formed of, for example, a dielectric ceramic including BaTiO₃, CaTiO₃, SrTiO₃, CaZrO₃, or the like as a main component. The dielectric ceramic may contain, as a subcomponent, a Mn compound, an Fe compound, a Cr compound, a Co compound, a Ni compound, or the like. A dimension of the dielectric layer 14 in the lamination direction T is set to about 0.30 μm or more and about 5.0 μm or less, for example, within manufacturing and measurement tolerances. The number of dielectric layers 14 is set to, for example, five or more and 6000 or less.

The inner electrodes 15 are formed of, for example, a metal material such as Ni, Cu, Sn, Ag, Pd, a Ag—Pd alloy, or Au. A dimension of the inner electrode 15 in the lamination direction T is set to 0.30 μm or more and 1.5 μm or less, for example, within manufacturing and measurement tolerances. The inner electrodes 15 include a plurality of end surface inner electrodes 20 and a plurality of side surface inner electrodes 50. The end surface inner electrodes 20 and the side surface inner electrodes 50 are alternately disposed in the lamination direction T. The end surface inner electrodes 20 and the side surface inner electrodes 50 are sometimes collectively referred to as the “inner electrodes 15.”

The end surface inner electrode 20 extends between both end surfaces C of the multilayer body 2 in the length direction L. Each end portion of the end surface inner electrode 20 in the length direction L is exposed at a respective one of the end surfaces C. The end surface inner electrode 20 is spaced apart from both side surfaces B in the width direction W by a predetermined distance. The end surface inner electrode 20 has a first opposing portion 21 and two first extended portions 22. The first opposing portion 21 is a portion of the end surface inner electrode 20 that is opposed to the side surface inner electrode 50 adjacent in the lamination direction T. The first opposing portion 21 is located at a central portion between the respective end surfaces C. Each first extended portion 22 is a portion of the end surface inner electrode 20 that is extended from the first opposing portion 21 toward a respective one of the end surface C sides. Each first extended portion 22 is exposed at a respective one of the end surfaces C.

Each end portion of the side surface inner electrode 50 in the width direction W is exposed at a respective one of the side surfaces B. The side surface inner electrode 50 is spaced apart from both end surfaces C in the length direction L by a predetermined distance. The side surface inner electrode 50 has a second opposing portion 51 and two second extended portions 52. The second opposing portion 51 is a portion of the side surface inner electrode 50 that is opposed to the end surface inner electrode 20 adjacent in the lamination direction T. The second opposing portion 51 is located at a central portion between the respective side surfaces B. Each second extended portion 52 is a portion of the side surface inner electrode 50 that is extended from the second opposing portion 51 toward a respective one of the side surface B sides. Each second extended portion 52 is exposed at a respective one of the side surfaces B.

When the inner electrodes 15 include Sn, electric field concentration at interfaces between the inner electrode 15 and the dielectric layer 14 can be alleviated, leading to improvement in reliability under a high-temperature load. In this case, Sn can sufficiently exhibit the effect even when being included in only the inner electrodes of either the end surface inner electrodes 20 or the side surface inner electrode 50.

The outer layer portions 12 may be formed of the same material as the dielectric layers 14 of the inner layer portion 11. The inner electrode 15 is not disposed in the outer layer portions 12.

Each end surface outer electrode 3 is disposed on a respective one of the end surfaces C of the multilayer body 2. Each end surface outer electrode 3 covers not only the end surface C but also each of portions of the main surfaces A and the side surfaces B on the end surface C side. The first extended portions 22 are each connected to a respective one of the end surface outer electrodes 3. Each end surface outer electrode 3 includes an underlying electrode layer 31 in contact with a surface of the multilayer body 2, a first plated layer 32 disposed on the underlying electrode layer 31, and a second plated layer 33 disposed on the first plated layer 32.

The underlying electrode layer 31 is, for example, a baked layer including a conductive metal such as copper (Cu), nickel (Ni), silver (Ag), palladium (Pd), or gold (Au), and glass including boron (B). The first plated layer 32 is, for example, a Ni plated layer. The second plated layer 33 is, for example, a tin (Sn) plated layer.

Each side surface outer electrode 4 is disposed on a respective one of the side surfaces B of the multilayer body 2. Each side surface outer electrode 4 covers not only the side surface B but also each of portions of the main surfaces A on the side surface B side. The second extended portions 52 are each connected to a respective one of the side surface outer electrodes 4. Each side surface outer electrode 4 includes an underlying electrode layer 41 in contact with a surface of the multilayer body 2, a first plated layer 42 disposed on the underlying electrode layer 41, and a second plated layer 43 disposed on the first plated layer 42.

The underlying electrode layer 41 is, for example, a baked layer including a conductive metal such as Cu, Ni, Ag, Pd, or Au, and glass including B. The first plated layer 42 is, for example, a Ni plated layer. The second plated layer 43 is, for example, a Sn plated layer.

However, the internal configuration of the multilayer body 2 and the configurations of the outer electrodes 3 and 4 are not limited to the above-described configurations, and can be modified as appropriate.

The mounting substrate 101 is a substrate on which the multilayer ceramic capacitor 1 is mounted. The mounting substrate 101 is formed of, for example, an insulating material such as a resin, glass, glass epoxy, paper phenol, or a ceramic. The mounting substrate 101 has a mounting surface 101a that is a surface on which the multilayer ceramic capacitor 1 is mounted.

The mounting surface 101a includes lands 102. The lands 102 are portions connected to the outer electrodes 3 and 4. The lands 102 are connected to wiring lines that are not depicted in the drawings. The lands 102 and the wiring lines are formed of, for example, a highly conductive metal such as Cu or Ag. The lands 102 include a pair of first lands 102A and a pair of second lands 102B.

The respective first lands 102A are lands connected to the respective end surface outer electrodes 3. The respective first lands 102A are spaced apart from each other on the mounting surface 101a. The respective second lands 102B are lands connected to the respective side surface outer electrodes 4. Each second land 102B is located at a substantially central portion between the respective first lands 102A in a direction in which the respective first lands 102A are arranged. The respective second lands 102B are spaced apart from each other in a direction orthogonal to the direction in which the respective first lands 102A are arranged.

Further, the multilayer ceramic capacitor 1 is mounted on the mounting substrate 101. The multilayer ceramic capacitor 1 is mounted on the lands 102 in such an orientation that the first main surface AA is disposed on the mounting surface 101a side. The respective end surface outer electrodes 3 are connected to the respective first lands 102A. The respective side surface outer electrodes 4 are connected to the respective second lands 102B. Each of the outer electrodes 3 and 4 is joined to a respective one of the lands 102 by, for example, solder 103. The method for joining the outer electrodes 3 and 4 to the lands 102 is not particularly limited, and may be, for example, joining by a conductive adhesive.

The cover 105 is disposed on the mounting surface 101a in a state in which the multilayer ceramic capacitor 1 is mounted thereon, and covers at least a portion of the multilayer ceramic capacitor 1. The cover 105 is formed of, for example, a resin. The cover 105 covers at least a portion of the multilayer ceramic capacitor 1 and at least a portion of the mounting substrate 101. The cover 105 covers, for example, each of the mounting surface 101a, the outer surfaces of the multilayer ceramic capacitor 1, and outer surfaces of the solder 103 over the entire region. In this case, the cover 105 covers the outer electrodes 3 and 4 and portions where the outer electrodes 3 and 4 are not disposed. The cover 105 covers a portion where the outer electrodes 3 and 4 are not disposed on the second main surface AB of the multilayer ceramic capacitor 1 over the entire region. The cover 105 is in close contact with the second main surface AB. The cover 105 covers a portion where the outer electrodes 3 and 4 are not disposed in the first main surface AA over the entire region. The cover 105 is in close contact with the first main surface AA.

In the multilayer ceramic capacitor 1, a surface roughness of the second main surface AB is higher than a surface roughness of the first main surface AA.

By increasing the surface roughness of the second main surface AB, an adhesion strength between the second main surface AB and the cover 105 can be increased, and thus keeping a stuck state between the second main surface AB and the cover 105 can be facilitated.

The second main surface AB is the surface on the opposite side of the surface on the mounting surface 101a side among the respective main surfaces A. When the surface on the opposite side of the surface on the mounting surface 101a side among the respective main surfaces A and the cover 105 are in a stuck state, the cover 105 can inhibit the multilayer body 2 from being deformed together with the mounting substrate 101. Thus, deformation of the multilayer body 2 attributed to stress transmission from the mounting substrate 101 to the multilayer body 2 can be favorably reduced or prevented by the cover 105.

Further, the first main surface AA is the surface on the mounting surface 101a side among the respective main surfaces A. When there are many recesses in the surface of the multilayer body 2 on the mounting surface 101a side, there is a possibility that stress transmitted from the mounting substrate 101 to the multilayer body 2 concentrates at the recesses and cracks occur in the vicinity of the recesses. However, by reducing the surface roughness of the first main surface AA, local stress concentration in the first main surface AA can be reduced or prevented, and thus the occurrence of cracks in the multilayer body 2 can be reduced or prevented.

The second main surface AB preferably has an arithmetic mean roughness Ra of about 0.66 μm or more, a core roughness depth Rk of about 1.74 μm or more, a reduced peak height Rpk of about 1.09 μm or more, a reduced valley depth Rvk of about 0.94 μm or more, a material portion Mr of about 11.00% or more, and a material portion Mr2 of about 88.00% or more, for example, within manufacturing and measurement tolerances.

The second main surface AB more preferably has an arithmetic mean roughness Ra of about 0.79 μm or more, a core roughness depth Rk of about 2.24 μm or more, a reduced peak height Rpk of about 1.26 μm or more, a reduced valley depth Rvk of about 1.00 μm or more, a material portion Mr of about 11.17% or more, and a material portion Mr2 of about 88.55% or more, for example, within manufacturing and measurement tolerances.

These features can favorably increase the adhesion strength between the second main surface AB of the multilayer body 2 and the cover 105. Accordingly, deformation of the multilayer body 2 attributed to external stress can be reduced or prevented more favorably.

The arithmetic mean roughness Ra is a roughness parameter defined in JIS B 0601-2001. The core roughness depth Rk, the reduced peak height Rpk, the reduced valley depth Rvk, the material portion Mr1, and the material portion Mr2 are roughness parameters defined in JIS B 0671-2002.

The arithmetic mean roughness Ra, the core roughness depth Rk, the reduced peak height Rpk, the reduced valley depth Rvk, the material portion Mr1, and the material portion Mr2 can be measured, for example, by observing each main surface with a laser microscope and performing image analysis. The observation magnification of the laser microscope is set to, for example, 20×. The image analysis can be performed, for example, by analysis software attached to the laser microscope.

The first main surface AA preferably has an arithmetic mean roughness Ra of about 0.58 μm or less, a core roughness depth Rk of about 1.37 μm or less, a reduced peak height Rpk of about 0.93 μm or less, a reduced valley depth Rvk of about 0.98 μm or less, a material portion Mr of about 10.00% or less, and a material portion Mr2 of about 84.00% or less, for example, within manufacturing and measurement tolerances.

The first main surface AA more preferably has an arithmetic mean roughness Ra of about 0.52 μm or less, a core roughness depth Rk of about 1.26 μm or less, a reduced peak height Rpk of about 0.93 μm or less, a reduced valley depth Rvk of about 0.91 μm or less, a material portion Mr of about 9.61% or less, and a material portion Mr2 of about 83.33% or less, for example, within manufacturing and measurement tolerances.

These features can favorably reduce or prevent local stress concentration in the first main surface AA of the multilayer body 2. Accordingly, the occurrence of cracks in the multilayer body 2 attributed to external stress can be reduced or prevented more favorably.

If the magnitude of the surface roughness of the second main surface AB and the magnitude of the surface roughness of the first main surface AA excessively differ, there is a possibility of the occurrence of warpage of the multilayer body 2 due to the Twyman effect. Thus, in order to prevent the occurrence of such warpage, the magnitude of the surface roughness of the second main surface AB is set within a range in which this magnitude is not too large with respect to the magnitude of the surface roughness of the first main surface AA, and the magnitude of the surface roughness of the first main surface AA is set within a range in which this magnitude is not too small with respect to the magnitude of the surface roughness of the second main surface AB.

Specifically, a value obtained by subtracting the arithmetic mean roughness Ra of the first main surface AA from the arithmetic mean roughness Ra of the second main surface AB is set to about 0.50 μm or less, for example, within manufacturing and measurement tolerances. A value obtained by subtracting the core roughness depth Rk of the first main surface AA from the core roughness depth Rk of the second main surface AB is set to about 1.40 μm or less, for example, within manufacturing and measurement tolerances. A value obtained by subtracting the reduced peak height Rpk of the first main surface AA from the reduced peak height Rpk of the second main surface AB is set to about 0.50 μm or less, for example, within manufacturing and measurement tolerances. A value obtained by subtracting the reduced valley depth Rvk of the first main surface AA from the reduced valley depth Rvk of the second main surface AB is set to about 0.50 μm or less, for example, within manufacturing and measurement tolerances. A value obtained by subtracting the material portion Mr of the first main surface AA from the material portion Mr of the second main surface AB is set to about 5.00% or less, for example, within manufacturing and measurement tolerances. A value obtained by subtracting the material portion Mr2 of the first main surface AA from the material portion Mr2 of the second main surface AB is set to about 10.00% or less, for example, within manufacturing and measurement tolerances.

Next, a non-limiting example of a manufacturing method for the multilayer ceramic capacitors 1 according to the example embodiments is described.

First, ceramic green sheets obtained by forming ceramic slurry in a sheet shape are prepared. Next, patterns of the end surface inner electrode 20 and the side surface inner electrode 50 are printed on the ceramic green sheets with a conductor paste. Thus, the ceramic green sheets on which the end surface inner electrode 20 are disposed and the ceramic green sheets on which the side surface inner electrode 50 are disposed are obtained. The patterns of the end surface inner electrode 20 and the side surface inner electrode 50 are formed by, for example, printing such as screen printing, gravure printing, or relief printing.

Next, the ceramic green sheets on which the end surface inner electrode 20 are disposed and the ceramic green sheets on which the side surface inner electrode 50 are disposed are alternately stacked. Next, ceramic green sheets for the outer layer portion, which become the outer layer portions 12, are each stacked on a respective one of both sides of the stacked ceramic green sheets in the lamination direction T. The ceramic green sheets for the outer layer portion are thermocompression-bonded to the ceramic green sheets. Accordingly, a mother block is obtained.

When the ceramic green sheets are pressure-bonded to each other, the stacked ceramic green sheets are clamped by a pair of plates from both sides in the lamination direction T. Shapes of surfaces of the plates are each transferred to a respective one of surfaces of the mother block opposed to each other in the lamination direction. One plate of the pair of plates has higher surface roughness than the other plate. Thus, surface roughness of one surface of the surfaces of the mother block opposed to each other in the lamination direction can be made higher than surface roughness of the other surface. Further, by adjusting the surface roughness of each plate, the surface roughness of each surface of the mother block can be adjusted.

Each outer layer portion 12 may be formed by laminating a plurality of ceramic green sheets, or may be formed of a single ceramic green sheet. Further, a included component may be different between the ceramic green sheets for the inner layer portion and the ceramic green sheets for the outer layer portion.

Next, the mother block is divided along cutting lines corresponding to dimensions of the multilayer body. The mother block is cut, for example, in the length direction L and the width direction W. Accordingly, a plurality of rectangular parallelepiped blocks (referred to as “multilayer chips”) are obtained. It is preferable that, for the multilayer chips, corner portions and ridge portions be rounded by, for example, barrel polishing.

Next, the multilayer chips are heated in a nitrogen atmosphere at a predetermined firing temperature for a predetermined time. Thereby, the multilayer bodies 2 are obtained. In the multilayer body 2, surface roughness of one surface of the pair of main surfaces A is higher than surface roughness of the other surface. Thus, in the multilayer body 2, of the pair of main surfaces A, the surface having the higher surface roughness can be used as the second main surface AB, and the surface having the lower surface roughness can be used as the first main surface AA.

Next, a conductive paste including copper and glass is applied to the respective side surfaces B of the multilayer body 2. Thus, the underlying electrode layers 41 of the side surface outer electrodes 4 are each formed on a respective one of the side surfaces B. Each underlying electrode layer 41 is formed so as to cover not only the side surface B but also portions of the main surfaces A on the side surface B side. Next, a conductive paste is applied to the respective end surfaces C of the multilayer body 2. Thus, the underlying electrode layers 31 of the end surface outer electrodes 3 are each formed on a respective one of the end surfaces C. Each underlying electrode layer 31 is formed so as to cover not only the end surface C but also portions of the main surfaces A and the side surfaces B on the end surface C side.

Next, the multilayer body 2 on which the underlying electrode layers 31 and the underlying electrode layers 41 are formed is heated in a nitrogen atmosphere at a predetermined firing temperature for a predetermined time. Thus, the underlying electrode layers 31 and the underlying electrode layers 41 are baked onto the multilayer body 2.

Next, the Ni plated layers 32 are formed on the underlying electrode layers 31, and the Ni plated layers 42 are formed on the underlying electrode layers 41. The Ni plated layers 32 and the Ni plated layers 42 are formed by, for example, a barrel plating method. Next, the Sn plated layers 33 are formed on the Ni plated layers 32, and the Sn plated layers 43 are formed on the Ni plated layers 42. The Sn plated layers 33 and the Ni plated layers 43 are formed by, for example, a barrel plating method. Accordingly, the end surface outer electrodes 3 and the side surface outer electrodes 4 are formed on the multilayer body 2.

Through the above process, the multilayer ceramic capacitor 1 depicted in FIG. 1 is obtained.

Next, a non-limiting example of a manufacturing method for the mounting structure 100 of the multilayer ceramic capacitor is described.

First, the solder 103 in a cream state is disposed on each land 102. The respective outer electrodes 3 and 4 of the multilayer ceramic capacitor 1 are each disposed on the solder 103 in a cream state. At this time, the multilayer ceramic capacitor 1 is oriented such that the first main surface AA (surface having the lower surface roughness) is opposed to the mounting surface 101a. The solder 103 is remelted by heating, and then is resolidified by cooling. Accordingly, the respective outer electrodes 3 and 4 and the respective lands 102 are joined by the solder 103, and the multilayer ceramic capacitor 1 is mounted on the mounting substrate 101.

Next, a resin sheet that becomes the cover 105 is prepared. The resin sheet is formed of an epoxy resin, a phenolic resin, a cyanate resin, or the like. The resin sheet is a thermosetting resin sheet. The resin sheet is brought into a semi-molten state by heating. The resin sheet in the semi-molten state is disposed on the mounting substrate 101. At this time, the resin sheet is disposed so as to cover the mounting surface 101a and the multilayer ceramic capacitor 1. Next, the mounting substrate 101 on which the resin sheet is disposed is left to stand in an environment in which the pressure has been reduced to near vacuum. Then, the resin sheet sticks to the second main surface AB of the multilayer body 2. The resin sheet wraps around the multilayer ceramic capacitor 1, and sticks to the first main surface AA. Thereafter, the resin sheet is left to stand until it solidifies. Accordingly, covering of the multilayer ceramic capacitor 1 with the cover 105 is completed.

The method for forming the cover 105 on the mounting surface 101a is not limited thereto. The cover 105 may be formed, for example, by dropping a liquid resin onto the mounting surface 101a. In this case, the resin may be shaped as appropriate with a blade or the like after being dropped. The shape of the resin after shaping is not particularly limited, and can be adjusted as appropriate.

Through the above process, the mounting structure 100 depicted in FIG. 1 is obtained.

Multilayer ceramic capacitors were fabricated as samples of experimental examples by the above-described manufacturing method. A peel test and a flexural test were performed using the samples of the experimental examples. As described in detail later, the peel test is a test for checking an adhesion strength between the cover and the multilayer body. The flexural test is a test for confirming an effect of reducing or preventing the occurrence of cracks.

As the samples of the experimental examples, the multilayer ceramic capacitors having a structure similar to that of the above-described multilayer ceramic capacitor 1 (structure depicted in FIGS. 1 to 3) were fabricated. As a manufacturing method for the multilayer ceramic capacitors of the samples, the manufacturing method according to the above-described example embodiment was adopted. As the experimental examples, experimental examples 1 to 8 were made. For each experimental example, ten multilayer ceramic capacitors of the samples were fabricated.

The multilayer ceramic capacitors of each experimental example were three-terminal multilayer ceramic capacitors. In each experimental example, the dimensions of each multilayer ceramic capacitor were L×W×T=1.2 mm×0.9 mm×0.5 mm. The electrostatic capacitance of each multilayer ceramic capacitor was 22 μF. However, surface roughness of the respective main surfaces A was different for each experimental example.

Next, the fabricated samples were evaluated in accordance with the following method. First, for each sample of the experimental examples, the surface roughness of the main surface of the multilayer body was measured. Next, the peel test was performed using the samples of experimental examples 1 to 4, and the flexural test was performed using the samples of experimental examples 5 to 8.

For each sample, the surface roughness of the main surface of the multilayer body was measured. As a measurement method for the surface roughness, the measurement method for the surface roughness described in the example embodiments was adopted. For each sample of experimental examples 1 to 4, the surface roughness of the second main surface was measured. For experimental examples 5 to 8, the surface roughness of the first main surface was measured. As parameters of the surface roughness, the arithmetic mean roughness Ra, the core roughness depth Rk, the reduced peak height Rpk, and the reduced valley depth Rvk were adopted.

For each experimental example, the values of the arithmetic mean roughness Ra, the core roughness depth Rk, the reduced peak height Rpk, and the reduced valley depth Rvk were each measured for the ten multilayer ceramic capacitors. For each experimental example, an average value of ten measurement values was calculated for each of the arithmetic mean roughness Ra, the core roughness depth Rk, the reduced peak height Rpk, and the reduced valley depth Rvk. The calculated average values were employed as the values of the arithmetic mean roughness Ra, the core roughness depth Rk, the reduced peak height Rpk, and the reduced valley depth Rvk for each experimental example.

The multilayer ceramic capacitors that were the samples of experimental examples 1 to 4 were mounted on a mounting substrate using a solder paste. Next, a liquid epoxy resin was dropped onto a mounting surface. The epoxy resin was pressed and spread in directions along the mounting surface by a pressing jig to be made into a film shape, and a state in which the epoxy resin covered the multilayer ceramic capacitors was made. The epoxy resin was brought into a state in which it covered the second main surfaces over the entire regions, and specifically, into a state in which it covered surfaces of the multilayer ceramic capacitors over the entire regions. Thereafter, the samples were left to stand to cure the epoxy resin.

Thereafter, the epoxy resin was clamped with tweezers, and was pulled in a direction away from the mounting surface. Then, it was checked whether or not the epoxy resin had peeled from the second main surface.

When the epoxy resin was completely separated from the second main surface, the sample of the check target was determined to have the “occurrence of peeling.” For each experimental example, when the number of samples determined to have the occurrence of peeling among the ten multilayer ceramic capacitors was zero, the result was evaluated as “good.” When the number was one or two, the result was evaluated as “generally good.” When the number was three or more, the result was evaluated as “defective.”

The multilayer ceramic capacitors that were the samples of experimental examples 5 to 8 were mounted on a mounting substrate using a solder paste. The orientation of the multilayer ceramic capacitors was such that the first main surfaces were opposed to the mounting substrate. The thickness of the mounting substrate was set to about 0.8 mm, for example, within manufacturing and measurement tolerances. Thereafter, a pressing jig was pressed against the surface of the mounting substrate on the side opposite to a mounting surface to bend the mounting substrate. A pressing rod having a diameter of about 5 mm was used as the pressing jig, for example, within manufacturing and measurement tolerances. The amount of deflection of the mounting substrate was set to about 2.0 mm, for example, within manufacturing and measurement tolerances. The mounting substrate was held in the bent state for five seconds.

Thereafter, the multilayer ceramic capacitors were removed from the mounting substrate, and the presence or absence of the occurrence of cracks was checked. Specifically, the multilayer body was polished from the side of the surface on the mounting surface side (first main surface) to expose an LW cross section passing through a central portion of the multilayer body in the lamination direction T. The polished surface was observed with a microscope to check whether or not cracks were present in the multilayer body. The observation magnification of the microscope was set to 40×.

When a crack was present at even one position in the polished surface, the sample of the observation target was determined to have the “occurrence of cracks.” For each experimental example, when the number of samples determined to have the occurrence of cracks among the ten multilayer ceramic capacitors was zero, the result was evaluated as “good.” When the number was one or two, the result was evaluated as “generally good.” When the number was three or more, the result was evaluated as “defective.”

Table 1 shows, for experimental examples 1 to 4, measurement results of the arithmetic mean roughness Ra, the core roughness depth Rk, the reduced peak height Rpk, and the reduced valley depth Rvk, and results of the peel test. Table 2 shows, for experimental examples 5 to 8, measurement results of the arithmetic mean roughness Ra, the core roughness depth Rk, the reduced peak height Rpk, and the reduced valley depth Rvk, and results of the flexural test.

TABLE 1

| | | | | | Peeling | |
|---|---|---|---|---|---|---|
| | | | | | Number of samples | |
| | Surface roughness of second main surface | | | | with occurrence | |
| | Ra (μm) | Rk (μm) | Rpk (μm) | Rvk (μm) | (pieces) | Determination |
| Experimental example 1 | 0.67 | 1.76 | 1.09 | 0.94 | 1/10 | Generally good |
| Experimental example 2 | 0.66 | 1.74 | 1.10 | 0.95 | 1/10 | Generally good |
| Experimental example 3 | 0.71 | 1.98 | 1.20 | 1.12 | 1/10 | Generally good |
| Experimental example 4 | 0.79 | 2.24 | 1.26 | 1.00 | 0/10 | Good |

TABLE 2

| | | | | | Crack | |
|---|---|---|---|---|---|---|
| | | | | | Number of samples | |
| | Surface roughness of first main surface | | | | with occurrence | |
| | Ra (μm) | Rk (μm) | Rpk (μm) | Rvk (μm) | (pieces) | Determination |
| Experimental example 5 | 0.50 | 1.21 | 0.88 | 0.87 | 0/10 | Good |
| Experimental example 6 | 0.52 | 1.26 | 0.93 | 0.91 | 0/10 | Good |
| Experimental example 7 | 0.58 | 1.37 | 0.93 | 0.98 | 1/10 | Generally good |
| Experimental example 8 | 0.45 | 1.11 | 0.80 | 0.77 | 0/10 | Good |

As shown in Table 1, in the peel test, a better result was obtained when the surface roughness of the second main surface was higher. This is considered to be because of the following reason. As various parameters of the surface roughness of the second main surface increase, the surface area of the second main surface increases. Thus, the contact area between the resin and the second main surface also increases, and an adhesion strength between the second main surface and the resin is improved. However, according to a comparison between experimental examples 3 and 4, it is suggested that the effect of reducing or preventing peeling of the resin is possibly not significantly improved even when the reduced valley depth Rvk is increased to a certain level or more. This is considered to be due to the following reason. Although the surface area of the second main surface increases as the reduced valley depth Rvk increases, the contact area between the resin and the second main surface does not increase beyond a certain level when there is a limit to the depth that the resin can reach in concave portions formed in the second main surface AB. Therefore, increasing at least one of the arithmetic mean roughness Ra, the core roughness depth Rk, and the reduced peak height Rpk with respect to the second main surface is considered to be particularly effective in terms of improving the adhesion strength between the resin and the second main surface.

The determination result regarding the presence or absence of peeling was “generally good” or “good” when, with respect to the second main surface, the arithmetic mean roughness Ra was about 0.66 μm or more, the core roughness depth Rk was about 1.74 μm or more, the reduced peak height Rpk was about 1.09 μm or more, and the reduced valley depth Rvk was about 0.94 μm or more, for example, within manufacturing and measurement tolerances. In addition, the determination result was “good” when, with respect to the second main surface, the arithmetic mean roughness Ra was about 0.79 μm, the core roughness depth Rk was about 2.24 μm, the reduced peak height Rpk was about 1.26 μm, and the reduced valley depth Rvk was about 1.00 μm (see experimental example 4), for example, within manufacturing and measurement tolerances.

Accordingly, it is confirmed that peeling of the cover from the second main surface can be reduced or prevented generally favorably when, with respect to the second main surface, the arithmetic mean roughness Ra is about 0.66 μm or more, the core roughness depth Rk is about 1.74 μm or more, the reduced peak height Rpk is about 1.09 μm or more, and the reduced valley depth Rvk is about 0.94 μm or more, for example, within manufacturing and measurement tolerances.

It is confirmed that peeling of the cover from the second main surface can be reduced or prevented more favorably when, with respect to the second main surface, the arithmetic mean roughness Ra is about 0.79 μm or more, the core roughness depth Rk is about 2.24 μm or more, the reduced peak height Rpk is 1.26 μm or more, and the reduced valley depth Rvk is about 1.00 μm or more, for example, within manufacturing and measurement tolerances.

As shown in Table 2, in the flexural test, a better result was obtained when the surface roughness of the first main surface was lower. According to a comparison between experimental examples 6 and 7, it is suggested that, while the magnitude of the reduced peak height Rpk does not significantly affect the occurrence of cracks, reducing the reduced valley depth Rvk can favorably reduce or prevent the occurrence of cracks. This is considered to be because the occurrence of cracks in the first main surface is attributable to an effect in which stress concentration occurs at the bottom of notches formed in the surface (that is, notch effect), and because reducing the depth of the notches is effective in terms of alleviating the stress concentration due to the notch effect. Therefore, reducing the reduced valley depth Rvk of the first main surface is considered to be particularly effective in terms of reducing or preventing the occurrence of cracks.

The determination result regarding the presence or absence of cracks in the multilayer body was “generally good” or “good” when, with respect to the first main surface, the arithmetic mean roughness Ra was about 0.58 μm or less, the core roughness depth Rk was about 1.37 μm or less, the reduced peak height Rpk was about 0.93 μm or less, and the reduced valley depth Rvk was about 0.98 μm or less, for example, within manufacturing and measurement tolerances. In addition, the determination result was “good” when, with respect to the first main surface, the arithmetic mean roughness Ra was about 0.52 μm or less, the core roughness depth Rk was about 1.26 μm or less, the reduced peak height Rpk was about 0.93 μm or less, and the reduced valley depth Rvk was about 0.91 μm or less (see experimental example 6), for example, within manufacturing and measurement tolerances.

Accordingly, it is confirmed that the occurrence of cracks in the multilayer body can be reduced or prevented generally favorably when, with respect to the first main surface, the arithmetic mean roughness Ra is about 0.58 μm or less, the core roughness depth Rk is about 1.37 μm or less, the reduced peak height Rpk is about 0.93 μm or less, and the reduced valley depth Rvk is about 0.98 μm or less, for example, within manufacturing and measurement tolerances.

It is confirmed that the occurrence of cracks in the multilayer body can be reduced or prevented more favorably when, with respect to the first main surface, the arithmetic mean roughness Ra is about 0.52 μm or less, the core roughness depth Rk is about 1.26 μm or less, the reduced peak height Rpk is about 0.93 μm or less, and the reduced valley depth Rvk is about 0.91 μm or less, for example, within manufacturing and measurement tolerances.

According to the present example embodiment, the following effects can be obtained.

According to the present example embodiment, in the multilayer ceramic capacitor, the surface roughness of the second main surface AB is higher than the surface roughness of the first main surface AA.

According to the present example embodiment, the mounting structure 100 of the multilayer ceramic capacitor includes the multilayer ceramic capacitor 1, the mounting substrate 101 including the mounting surface 101a on which the multilayer ceramic capacitor 1 is mounted, and the cover 105 that is disposed on the mounting surface 101a and covers the multilayer ceramic capacitor 1. The multilayer ceramic capacitor 1 is mounted on the mounting substrate 101 such that the first main surface AA faces the mounting surface 101a side, and the cover 105 abuts against the second main surface AB.

In this case, the second main surface AB is the surface on the opposite side of the surface on the mounting surface 101a side among the respective main surfaces A. By increasing the surface roughness of the second main surface AB, the adhesion strength between the second main surface AB and the cover 105 can be increased, and thus keeping a stuck state between the second main surface AB and the cover 105 can be facilitated. When the surface on the opposite side of the surface on the mounting surface 101a side among the respective main surfaces A and the cover 105 are in a stuck state, the cover 105 can inhibit the multilayer body 2 from attempting to be deformed together with the mounting substrate 101. Thus, deformation of the multilayer body 2 attributed to stress transmission from the mounting substrate 101 to the multilayer body 2 can be favorably reduced or prevented by the cover 105.

Further, the first main surface AA is the surface on the mounting surface 101a side among the respective main surfaces A. When recesses are present in the surface of the multilayer body 2 on the mounting surface 101a side, there is a possibility that stress transmitted from the mounting substrate 101 to the multilayer body 2 concentrates at the recesses and cracks occur in the vicinity of the recesses. However, by reducing the surface roughness of the first main surface AA, local stress concentration in the first main surface AA can be reduced or prevented, and thus the occurrence of cracks in the multilayer body 2 can be reduced or prevented.

Therefore, it is possible to provide the multilayer ceramic capacitor 1 capable of reducing or preventing damage to the multilayer ceramic capacitor by being mounted such that the first main surface AA faces the mounting substrate side. Further, it is possible to provide the mounting structure 100 capable of reducing or preventing damage to the multilayer ceramic capacitor. Thus, it is possible to provide the multilayer ceramic capacitor 1 and the mounting structure 100 that facilitate reduction or prevention of damage to the multilayer ceramic capacitor.

According to the present example embodiment, the second main surface AB has an arithmetic mean roughness Ra of about 0.79 μm or more, a core roughness depth Rk of about 2.24 μm or more, a reduced peak height Rpk of about 1.26 μm or more, a reduced valley depth Rvk of about 1.00 μm or more, a material portion Mr of about 11.17% or more, and a material portion Mr2 of about 88.55% or more, for example, within manufacturing and measurement tolerances.

According to such a configuration, the adhesion strength between the second main surface AB of the multilayer body 2 and the cover 105 can be favorably increased. Accordingly, it is possible to further facilitate reduction or prevention of deformation of the multilayer body 2 attributed to external stress transmitted from the mounting substrate 101.

According to the present example embodiment, the first main surface AA has an arithmetic mean roughness Ra of about 0.52 μm or less, a core roughness depth Rk of about 1.26 μm or less, a reduced peak height Rpk of about 0.93 μm or less, a reduced valley depth Rvk of about 0.91 μm or less, a material portion Mr of about 9.61% or less, and a material portion Mr2 of about 83.33% or less, for example, within manufacturing and measurement tolerances.

According to such a configuration, local stress concentration in the first main surface AA of the multilayer body 2 can be favorably reduced or prevented. Accordingly, it is possible to further facilitate reduction or prevention of the occurrence of cracks in the multilayer body 2 attributed to external stress transmitted from the mounting substrate 101.

Although the example embodiments of the present invention have been described above, the present invention is not limited to the above-described example embodiments, and various changes and modifications are possible.

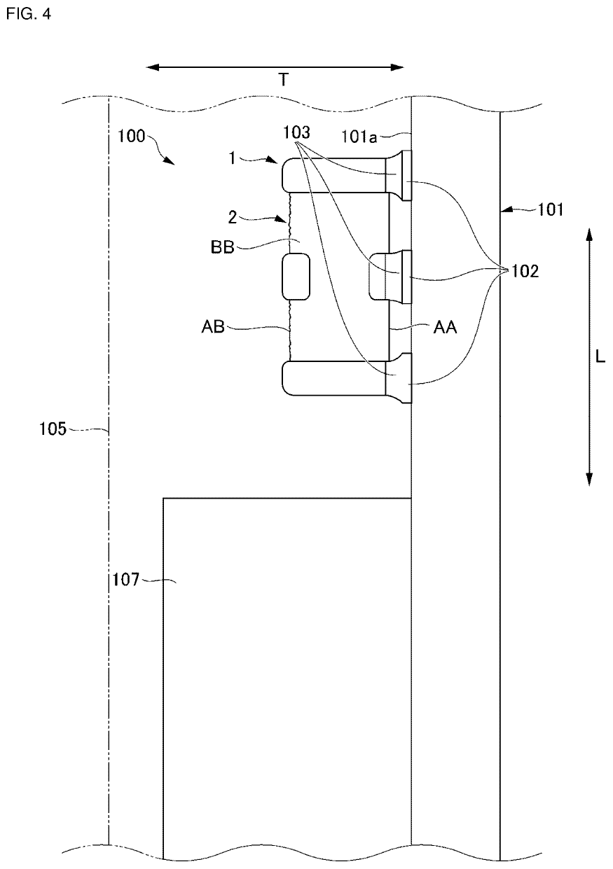

An electronic component other than the multilayer ceramic capacitor may be disposed on the mounting substrate. The cover may cover, together with the multilayer ceramic capacitor, the electronic component other than the multilayer ceramic capacitor. For example, as depicted in FIG. 4, in the mounting structure 100 of a modification, the multilayer ceramic capacitor 1 and a chip 107 such as a CPU are mounted on the mounting substrate 101 (mounting surface 101a). The cover 105 covers, for example, the chip 107, the mounting surface 101a, and the multilayer ceramic capacitor 1. Further, the cover 105 is not necessarily required to cover the entire outer surfaces of the multilayer ceramic capacitor 1, and may cover, for example, only a portion of the second main surface AB of the multilayer body 2 on the chip 107 side. Even in such a case, by increasing the surface roughness of the second main surface, deformation of the multilayer body due to external stress transmitted from the mounting substrate 101 can be reduced or prevented. However, it is preferable that the outer surfaces of the multilayer ceramic capacitor 1 be covered over a wider range in terms of an advantage that the adhesion strength between the second main surface and the cover can be improved more favorably.

In the above example embodiments, the multilayer ceramic capacitor 1 is the three-terminal multilayer ceramic capacitor 1. However, the present invention is not limited thereto. For example, in a multilayer ceramic capacitor (so-called two-terminal multilayer ceramic capacitor) that includes a multilayer body and a pair of outer electrodes provided as a pair on either the respective side surfaces or the respective end surfaces of the multilayer body and in which the multilayer body has inner electrodes connected to only one of the pair of outer electrodes and inner electrodes connected to only the other, the first main surface and the second main surface of the multilayer body may have surface properties corresponding to those of the above example embodiments. In this case, effects similar to those of the above example embodiments can be obtained. Further, the internal structure of the multilayer body (for example, the shape of the inner electrodes and the like) is not particularly limited.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of dielectric layers and a plurality of inner electrodes, a first main surface and a second main surface facing each other in a lamination direction, a first side surface and a second side surface facing each other in a width direction orthogonal to the lamination direction, and a first end surface and a second end surface facing each other in a length direction orthogonal to the lamination direction and the width direction; and
outer electrodes provided as a pair on at least one of the pair of side surfaces or the pair of end surfaces; wherein
a surface roughness of the second main surface is higher than a surface roughness of the first main surface.

2. The multilayer ceramic capacitor according to claim 1, wherein the second main surface has an arithmetic mean roughness Ra of about 0.79 μm or more, a core roughness depth Rk of about 2.24 μm or more, a reduced peak height Rpk of about 1.26 μm or more, a reduced valley depth Rvk of about 1.00 μm or more, a material portion Mr1 of about 11.17% or more, and a material portion Mr2 of about 88.55% or more.

3. The multilayer ceramic capacitor according to claim 1, wherein the first main surface has an arithmetic mean roughness Ra of about 0.52 μm or less, a core roughness depth Rk of about 1.26 μm or less, a reduced peak height Rpk of about 0.93 μm or less, a reduced valley depth Rvk of about 0.91 μm or less, a material portion Mr1 of about 9.61% or less, and a material portion Mr2 of about 83.33% or less.

4. The multilayer ceramic capacitor according to claim 1, wherein the multilayer ceramic capacitor is a three-terminal capacitor.

5. The multilayer ceramic capacitor according to claim 1, wherein the plurality of inner electrodes include Sn.

6. The multilayer ceramic capacitor according to claim 1, wherein the second main surface has an arithmetic mean roughness Ra of about 0.66 μm or more, a core roughness depth Rk of about 1.74 μm or more, a reduced peak height Rpk of about 1.09 μm or more, a reduced valley depth Rvk of about 0.94 μm or more, a material portion Mr1 of about 11.00% or more, and a material portion Mr2 of about 88.00% or more.

7. The multilayer ceramic capacitor according to claim 1, wherein the first main surface has an arithmetic mean roughness Ra of about 0.58 μm or less, a core roughness depth Rk of about 1.37 μm or less, a reduced peak height Rpk of about 0.93 μm or less, a reduced valley depth Rvk of about 0.98 μm or less, a material portion Mr1 of about 10.00% or less, and a material portion Mr2 of about 84.00% or less.

8. The multilayer ceramic capacitor according to claim 1, wherein a difference between an arithmetic mean roughness Ra of the first main surface and an arithmetic mean roughness Ra of the second main surface is about 0.50 μm or less.

9. The multilayer ceramic capacitor according to claim 1, wherein a difference between a core roughness depth Rk of the first main surface and a core roughness depth Rk of the second main surface is about 1.40 μm or less.

10. The multilayer ceramic capacitor according to claim 1, wherein a difference between a reduced peak height Rpk of the first main surface and a reduced peak height Rpk of the second main surface is about 0.50 μm or less.

11. The multilayer ceramic capacitor according to claim 1, wherein a difference between a reduced valley depth Rvk of the first main surface and a reduced valley depth Rvk of the second main surface is about 0.50 μm or less.

12. The multilayer ceramic capacitor according to claim 1, wherein a difference between a material portion Mr1 of the first main surface and a material portion Mr1 of the second main surface is about 5.00% or less.

13. The multilayer ceramic capacitor according to claim 1, wherein a difference between a material portion Mr2 of the second main surface and a material portion Mr2 of the second main surface is about 10.00% or less.

14. A mounting structure of a multilayer ceramic capacitor, comprising:
the multilayer ceramic capacitor according to claim 1;
a mounting substrate including a mounting surface on which the multilayer ceramic capacitor is mounted; and
a cover located on the mounting surface to cover at least a portion of the multilayer ceramic capacitor; wherein
the multilayer ceramic capacitor is mounted on the mounting substrate such that the first main surface faces the mounting surface side; and
the cover abuts against the second main surface.

15. The mounting structure according to claim 14, wherein the cover covers at least a portion of the mounting substrate.

16. The mounting structure according to claim 14, wherein the cover covers the mounting surface, outer surfaces of the multilayer ceramic capacitor, and outer surfaces of solder joining the multilayer ceramic capacitor to the mounting surface.

17. The mounting structure according to claim 14, wherein the second main surface has an arithmetic mean roughness Ra of about 0.79 μm or more, a core roughness depth Rk of about 2.24 μm or more, a reduced peak height Rpk of about 1.26 μm or more, a reduced valley depth Rvk of about 1.00 μm or more, a material portion Mr1 of about 11.17% or more, and a material portion Mr2 of about 88.55% or more.

18. The mounting structure according to claim 14, wherein the first main surface has an arithmetic mean roughness Ra of about 0.52 μm or less, a core roughness depth Rk of about 1.26 μm or less, a reduced peak height Rpk of about 0.93 μm or less, a reduced valley depth Rvk of about 0.91 μm or less, a material portion Mr1 of about 9.61% or less, and a material portion Mr2 of about 83.33% or less.

19. The mounting structure according to claim 14, wherein the second main surface has an arithmetic mean roughness Ra of about 0.66 μm or more, a core roughness depth Rk of about 1.74 μm or more, a reduced peak height Rpk of about 1.09 μm or more, a reduced valley depth Rvk of about 0.94 μm or more, a material portion Mr1 of about 11.00% or more, and a material portion Mr2 of about 88.00% or more.

20. The mounting structure according to claim 14, wherein the first main surface has an arithmetic mean roughness Ra of about 0.58 μm or less, a core roughness depth Rk of about 1.37 μm or less, a reduced peak height Rpk of about 0.93 μm or less, a reduced valley depth Rvk of about 0.98 μm or less, a material portion Mr1 of about 10.00% or less, and a material portion Mr2 of about 84.00% or less.
